(19) United States
(12) Patent Application Publication
(10) Pub. No.: US 2026/0305640 A1
(43) Pub. Date: Oct. 8, 2026

(54) BISCUIT SPREAD COMPOSITIONS AND METHODS FOR PRODUCING THEREOF

(71) Applicant: MDSA FOOD INDUSTRIES LTD, Maalot (IL)

(72) Inventor: Ziv SHERMAN, Shave Zion (IL)

(21) Appl. No.: 19/481,314

(22) PCT Filed: Nov. 4, 2024
(86) PCT No.: PCT/IL2024/051054

§ 371 Date: Nov. 4, 2025

(30) Foreign Application Priority Data
Nov. 9, 2023 (IL) 308425

(51) Int. Cl. A23D 7/005; A21D 13/20; A23G 3/40; A23G 3/42; A23G 3/54; A23L 29/10

(52) U.S. Cl. CPC A23D 7/0056; A21D 13/20; A23G 3/40; A23G 3/42; A23G 3/54; A23L 29/10

(57) ABSTRACT

The present invention, in some embodiments, provides a cookie biscuit spread compositions comprising 30-45% (w/w) sugar, 25-35% (w/w) cookie biscuit, and 15-35% (w/w) vegetable fat, wherein the spread is characterized by a viscosity in the range of: 5,000-15,000 Cp at 40° C. Further provided are methods for preparing the biscuit spread compositions disclosed herein, comprising the steps of: (a) providing the cookie biscuit spread ingredients disclosed herein at room temperature; and (b) gradually adding the sugar and the cookie biscuit to the vegetable fat in a mill and grinding the cookie spread ingredients until a desired texture is achieved, wherein the desired texture is characterized by a Dv90 particle size of less than or equal to about 30 μm.

### FIELD OF THE INVENTION

The present invention is in the field of biscuit spread compositions and methods for manufacturing thereof.

### BACKGROUND OF THE INVENTION

Biscuit spreads, a category of confectionery products derived from broken biscuits or cookies, have established a strong presence in the consumer food industry. Notable among these is the well-recognized Lotus Biscoff Spread, which utilizes Lotus Biscoff cookies to craft a delectable and iconic spread.

Organoleptic tests indicate a strong inverse correlation between overall satisfaction with product taste and texture and particle size. Satisfaction increases as particle size is reduced, concomitantly with a uniformly spreadable texture.

BE1018524A3 describes a method for preparing a non-baked, room-temperature spreadable confectionery paste in which a quantity of ground cookies is mixed with a quantity of fat. The method comprises the following steps: a) Mixing ground cookies into grains to form a fat-based suspension, b) Further reducing the particle size of the grains present in the mixture, and c) Cooling the suspension obtained. The further reduction of particle size described in step (b) is performed at elevated temperatures, preferably at least 40° C.

As the market for biscuit spreads continues to expand and evolve, there is an unmet need for new formulas and highly efficient methods for producing biscuit spreads having smooth texture concomitantly with reduced particles size, without the need for heating, and while preserving the taste and flavor of the spread.

### SUMMARY OF THE INVENTION

According to a first aspect there is provided a cookie biscuit spread comprising 30-45% (w/w) sugar, 25-35% (w/w) cookie biscuit, and 15-35% (w/w) vegetable fat, wherein the spread is characterized by a viscosity in the range of: 5,000-15,000 Cp at 40° C.

In some embodiments, the cookie biscuit spread is characterized by a Dv90 particle size of less than or equal to about 30 μm, said Dv90 is a diameter at which 90% of the particles by volume are smaller than or equal to the diameter.

In some embodiments, the cookie biscuit spread further comprises 0.5-2.5% (w/w) emulsifier.

In some embodiments, the cookie biscuit spread further comprises 1-10% (w/w) an extract providing a flavor of maple, vanilla, or both.

In some embodiments, the sugar is sucrose.

In some embodiments, the vegetable fat is coconut fat, canola oil, palm oil or any combination thereof.

In some embodiments, the emulsifier is soy lecithin.

In some embodiments, the cookie biscuit spread comprises 30-45% (w/w) sucrose, 25-35% (w/w) cookie biscuit, 15-20% (w/w) coconut fat, 1-4% (w/w) vanilla extract, 0.5-2.5% (w/w) soy lecithin, 1.5-4% (w/w) maple syrup, and 4-8% (w/w) canola oil.

According to another aspect, there is provided a method for preparing a biscuit spread comprising the steps of:
a. providing a cookie spread ingredients at room temperature comprising 30-45% (w/w) sugar, 25-35% (w/w) cookie biscuit, and 15-35% (w/w) vegetable fat; and,
b. gradually adding said sugar and said cookie biscuit to said vegetable fat in a mill and grinding the cookie spread ingredients in the mill until a desired texture is achieved, wherein grinding is performed at room temperature, further wherein the desired texture is characterized by a Dv90 particle size of less than or equal to about 30 μm, said Dv90 is a diameter at which 90% of the particles by volume are smaller than or equal to the diameter.

In some embodiments, the desired texture is characterized by viscosity within the range of: 9,000-12,000 Cp at 40° C.

In some embodiments, the mill is selected from: a ball mill, millstones, an autogenous mill, a buhrstone mill, high pressure grinding rolls, a pebble mill, a rod mill, a semi-autogenous (SAG) mill, a tower mill, and a vertical shaft impactor mill (VSI mill).

In some embodiments, the mill is millstones or a ball mill.

In some embodiments, said step (b) is performed for a predetermined time.

In some embodiments, gradually adding is adding the sugar and the cookie biscuit during a period of about 30 minutes.

In some embodiments, the predetermined time is in the range between 2 hr and 4 hr.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The presently disclosed subject matter may be more clearly understood upon reading of the following detailed description embodiments of non-limiting exemplary embodiments thereof, with reference to the drawings.

The following detailed description of embodiments of the presently disclosed subject matter refers to accompanying drawings. Dimensions of components and features shown in figures are chosen for convenience or clarity of presentations and are not necessarily shown to scale. Wherever possible, the same reference numbers will be used throughout the drawings and the following description to refer to the same and like parts.

FIG. 1 includes a line graph and a table demonstrating Gas chromatography (GC) for Petit-Beurre sample.

FIGS. 2A-2E includes tables and line graphs demonstrating GC Chromatogram for compounds 1 (FIG. 2A), 4 (FIG. 2B), 6 (FIG. 2C), 7 (FIG. 2D), and 8 (FIG. 2E) in Petit-Beurre sample.

FIG. 3 is a radar chart demonstrating the texture and color of chopper-made Dairy Petit-Beurre spread (sample 1), mills-made non-dairy Petit-Beurre spread (sample 2), and non-Petit Beurre Biscuit spread (sample 3).

FIG. 4 is a radar chart demonstrating the smell characteristics of chopper-made Dairy Petit-Beurre spread (sample 1), mills-made non-dairy Petit-Beurre spread (sample 2), and non-Petit Beurre Biscuit spread (sample 3).

FIG. 5 is a radar chart demonstrating the saltiness, sweetness, acidity and bitterness of chopper-made Dairy Petit-Beurre spread (sample 1), mills-made non-dairy Petit-Beurre spread (sample 2), and non-Petit Beurre Biscuit spread (sample 3).

FIG. 6 is a radar chart demonstrating the taste characteristics of chopper-made Dairy Petit-Beurre spread (sample 1), mills-made non-dairy Petit-Beurre spread (sample 2), and non-Petit Beurre Biscuit spread (sample 3).

### DETAILED DESCRIPTION OF THE PREFERRED EMBODIMENTS

### Petit Beurre Spread Compositions

According to a first aspect, there is provided a Petit Beurre spread composition comprising: Petit-Beurre biscuit, sugar, vegetable fat, and an emulsifier. In some embodiments, the Petit Beurre spread comprises: Petit-Beurre biscuit, sugar, vegetable oil, an emulsifier, and an extract providing a flavor of maple, vanilla, or both.

As used herein, the term “Petit Beurre”, refers to a type of sweet baked biscuit. The Petit Beurre biscuit is known to be characterized by its distinct rectangular shape with scalloped edges and a pattern of small holes on the surface. It is noted that although the name “Petit Beurre” is translated to “little butter” in French, the Petit Beurre biscuit does not necessary comprise butter. Both dairy and non-dairy versions of Petit Beurre biscuits are available. Traditional Petit Beurre biscuits are dairy biscuits and are made with butter comprising lactose. Non-Dairy or Vegan Petit Beurre Biscuits are made without dairy butter and may use plant-based fats such as vegetable oils as a substitute for butter.

Non limiting examples for Petit Beurre biscuits include but are not limited to the Petit Beurre of the LU Company, and the Petit Beurre of Osem Company. The Petit Beurre is also termed “Petibor” in Turkey and “Πτι-Mπερ”/“PteeBer” in Greece.

In some embodiments, the water content in the Petit Beurre disclosed herein is lower than 10% (w/w). In some embodiments, the water content in the Petit Beurre disclosed herein is lower than 9%, 8%, 7%, 6% or 5% (w/w). Each possibility represents a separate embodiment of the present invention. In some embodiments, the water content in the Petit Beurre disclosed herein is lower than 5% (w/w).

In some embodiments, the Petit Beurre biscuit disclosed herein is a non-dairy biscuit.

In some embodiments, sugar is a natural. In some embodiments, sugar is derived from a natural product. In some embodiments, the term “derived from” encompasses any industrial processing such as extraction, isolation, purification, fractionation, fermentation, or chemical modification. In some embodiments, sugar is a synthetic product. Non-limiting examples of sugar include but are not limited to powdered sugar, caster sugar, brown sugar, granulated sugar, demerara sugar, muscovado sugar, maple sugar, coconut sugar, date sugar, maple syrup, honey, agave nectar, corn syrup, stevia, fructose, glucose, sucrose, lactose, malatose, galactose, or any combination thereof. In some embodiments, the sugar is or comprises powdered sugar. In some embodiments, the sugar is or comprises sucrose.

In some embodiments, the vegetable fat comprises vegetable oil. In some embodiments, the vegetable oil is selected from: canola oil, sunflower oil, soybean oil, palm oil or refined palm oil, and corn oil. In some embodiments, the vegetable fat is at least one plant-derived fat selected from: coconut fat, canola oil, and both. In some embodiments, the coconut fat is a hardened coconut fat. In some embodiments, hardened coconut fat comprises saturated fats. In some embodiments, saturated fats comprise lauric acid, myristic acid, palmitic acid, and any combination thereof. In some embodiments, canola oil comprises at least one fat selected from: monounsaturated and polyunsaturated fats.

As used herein, the term “hardened coconut fat”, or “hydrogenated coconut fat”, refers to a type of fat derived from coconut oil through a hydrogenation process. The components of hardened coconut fat primarily consist of various types of lipids, which are a combination of both saturated and unsaturated fats.

As used herein, the term “emulsifier” refers to an ingredient that is used in food products to help blend and stabilize ingredients that do not naturally mix well.

Non limiting examples for emulsifiers include: Lecithin, Mono- and diglycerides, Polysorbate 80 (Tween 80), Sodium Stearoyl Lactylate (SSL), Acacia Gum (or Gum Arabic), Carrageenan, Xanthan Gum, Diacetyl Tartaric Acid Esters of Mono- and Diglycerides (DATEM), Propylene Glycol Esters (PGMS), and Glycerol Monostearate (GMS).

In some embodiments, the emulsifier comprises lecithin. In some embodiments, lecithin is selected from: soy lecithin, sunflower lecithin and egg yolk lecithin. In some embodiments, the emulsifier is soy lecithin. In some embodiments, the emulsifier is derived from soybeans. In some embodiments, the emulsifier comprises phospholipids. In some embodiments, the phospholipids are phosphatidylcholine, phosphatidylethanolamine, and both.

In some embodiments, vanilla extract comprises vanilla flavor compounds. In some embodiments, vanilla flavor compound is selected from Vanillin, Ethylvanillin, and both.

In some embodiments, maple comprises a natural maple syrup. In some embodiments, maple comprises maple flavoring compounds.

As used herein, the term “spread” encompasses a semi-solid or soft-textured food product typically made by combining various ingredients, often including fats or oils, with other flavorings or additives. Spreads are designed to be easily spreadable onto other foods, such as bread, crackers, or other baked goods. Spreads are commonly used as condiments, toppings, or fillings and are versatile in culinary applications.

As used herein, the term “oil” encompasses a type of lipid that is typically in a liquid form at room temperature or slightly above. Oil is primarily composed of triglycerides, which consist of three fatty acid molecules bonded to a glycerol molecule. The term “fat” used herein refers to a type of lipid that exists in both liquid and solid forms at room temperature, depending on its composition. Dietary fats can be categorized as saturated fats, unsaturated fats (e.g., monounsaturated and polyunsaturated fats), and trans fats.

In some embodiments, the sugar content in the Petit Beurre spread by weight is in the range of 20-50%, 25-50%, 30-50%, 35-50%, 20-45%, 25-45%, 30-45%, 35-45%, 30-50%, 30-45%, 35-50%, and 35-45%. Each possibility represents a separate embodiment of the present invention. In some embodiments, the sugar content in the Petit Beurre spread by weight is in the range of 35-44%, 35-43%, 35-42%, 35-41%, 35-40%, 36-45%, 36-44%, 36-43%, 36-42%, 36-41%, 36-40%, 37-45%, 37-44%, 37-43%, 37-42%, 37-41%, 37-40%, 38-45%, 38-44%, 38-43%, 38-42%, 38-41%, and 38-40%. Each possibility represents a separate embodiment of the present invention. In some embodiments, the sugar content in the Petit Beurre spread by weight is about 39%.

In some embodiments, the Petit Beurre biscuit content in the Petit Beurre spread disclosed herein by weight is in the range of 20-40%, 25-40%, 20-35%, and 25-35%. Each possibility represents a separate embodiment of the present invention. In some embodiments, the Petit Beurre biscuit content in the Petit Beurre spread by weight is in the range of 25-34%, 25-33%, 25-32%, 25-31%, 25-30%, 26-35%, 26-34%, 26-33%, 26-32%, 26-31%, 26-30%, 27-35%, 27-34%, 27-33%, 27-32%, 27-31%, 27-30%, 28-35%, 28-34%, 28-33%, 28-32%, 28-31%, and 28-30%. Each possibility represents a separate embodiment of the present invention. In some embodiments, the Petit Beurre biscuit content in the Petit Beurre spread by weight is about 29%.

In some embodiments, the fat content in the Petit Beurre spread disclosed herein by weight is in the range of 10-40%, 10-35%, 10-30%, 15-40%, 15-35%, 15-30%, 20-40%, 20-35%, and 20-30%. Each possibility represents a separate embodiment of the present invention. In some embodiments, the fat content in the Petit Beurre spread by weight is in the range of 20-29%, 20-28%, 20-27%, 20-26%, 21-30%, 21-29%, 21-28%, 21-27%, 21-26%, 22-30%, 22-29%, 22-28%, 22-27%, 22-26%, 23-30%, 23-29%, 23-28%, 23-27%, 23-26%, 24-30%, 24-29%, 24-28%, 24-27%, and 24-26%. Each possibility represents a separate embodiment of the present invention. In some embodiments, the fat content in the Petit Beurre spread by weight is about 25%. In some embodiments, the fat is vegetable fat.

In some embodiments, the Petit Beurre spread disclosed herein comprises: 30-45% (w/w) sugar, 25-35% (w/w) Petit Beurre biscuit, and 15-30% (w/w) vegetable oil or vegetable fat.

In some embodiments, the emulsifier content in the Petit Beurre spread by weight is in the range of 0.1-3%. In some embodiments, the emulsifier content in the Petit Beurre spread by weight is in the range of 0.5-2.5%. In some embodiments, the emulsifier content in the Petit Beurre spread by weight is in the range of 0.5-2.4%, 0.5-2.3%, 0.5-2.2%, 0.5-2.1%, 0.5-2.0%, 0.5-1.9%, 0.5-1.8%, 0.5-1.7%, 0.6-2.5%, 0.6-2.4%, 0.6-2.3%, 0.6-2.2%, 0.6-2.1%, 0.6-2.0%, 0.6-1.9%, 0.6-1.8%, 0.6-1.7%, 0.7-2.5%, 0.7-2.4%, 0.7-2.3%, 0.7-2.2%, 0.7-2.1%, 0.7-2.0%, 0.7-1.9%, 0.7-1.8%, 0.7-1.7%, 0.8-2.5%, 0.8-2.4%, 0.8-2.3%, 0.8-2.2%, 0.8-2.1%, 0.8-2.0%, 0.8-1.9%, 0.8-1.8%, 0.8-1.7%, 0.9-2.5%, 0.9-2.4%, 0.9-2.3%, 0.9-2.2%, 0.9-2.1%, 0.9-2.0%, 0.9-1.9%, 0.9-1.8%, 0.9-1.7%, 1.0-2.5%, 1.0-2.4%, 1.0-2.3%, 1.0-2.2%, 1.0-2.1%, 1.0-2.0%, 1.0-1.9%, 1.0-1.8%, 1.0-1.7%, 1.1-2.5%, 1.1-2.4%, 1.1-2.3%, 1.1-2.2%, 1.1-2.1%, 1.1-2.0%, 1.1-1.9%, 1.1-1.8%, 1.1-1.7%, 1.2-2.5%, 1.2-2.4%, 1.2-2.3%, 1.2-2.2%, 1.2-2.1%, 1.2-2.0%, 1.2-1.9%, 1.2-1.8%, 1.2-1.7%, 1.3-2.5%, 1.3-2.4%, 1.3-2.3%, 1.3-2.2%, 1.3-2.1%, 1.3-2.0%, 1.3-1.9%, 1.3-1.8%, 1.3-1.7%, 1.4-2.5%, 1.4-2.4%, 1.4-2.3%, 1.4-2.2%, 1.4-2.1%, 1.4-2.0%, 1.4-1.9%, 1.4-1.8%, 1.4-1.7%, 1.5-2.5%, 1.5-2.4%, 1.5-2.3%, 1.5-2.2%, 1.5-2.1%, 1.5-2.0%, 1.5-1.9%, 1.5-1.8%, and 1.5-1.7%. Each possibility represents a separate embodiment of the present invention.

In some embodiments, the Petit Beurre spread comprises 1-10% (w/w) an extract providing a flavor of maple, vanilla, or both. In some embodiments, the Petit Beurre spread comprises 1-10%, 2-10%, 3-10%, 4-10%, 5-10%, 6-10%, 7-10%, 8-10%, 9-10%, 1-9%, 2-9%, 3-9%, 4-9%, 5-9%, 6-9%, 7-9%, 8-9%, 1-8%, 2-8%, 3-8%, 4-8%, 5-8%, 6-8%, 7-8%, 1-7%, 2-7%, 3-7%, 4-7%, 5-7%, 6-7%, 1-6%, 2-6%, 3-6%, 4-6%, 5-6%, 1-5%, 2-5%, 3-5%, 4-5%, 1-4%, 2-4%, 3-4%, 1-3%, 2-3%, 1-2% (w/w) an extract providing a flavor of maple, vanilla, or both. Each possibility represents a separate embodiment of the present invention.

In some embodiments, the maple extract or syrup content in the Petit Beurre spread by weight is in the range of 1.0-4.0%. In some embodiments, the maple extract content in the Petit Beurre spread by weight is in the range of 1.0-3.5%, 1.5-4.0%, 1.5-3.5%, 2.0-4.0%, and 2.0-3.5%. Each possibility represents a separate embodiment of the invention. In some embodiments, the maple extract content in the Petit Beurre spread by weight is in the range of 2.0-3.4%, 2.0-3.3%, 2.0-3.2%, 2.0-3.1%, 2.0-3.0%, 2.0-2.9%, 2.1-3.5%, 2.1-3.4%, 2.1-3.3%, 2.1-3.2%, 2.1-3.1%, 2.1-3.0%, 2.1-2.9%, 2.2-3.5%, 2.2-3.4%, 2.2-3.3%, 2.2-3.2%, 2.2-3.1%, 2.2-3.0%, 2.2-2.9%, 2.3-3.5%, 2.3-3.4%, 2.3-3.3%, 2.3-3.2%, 2.3-3.1%, 2.3-3.0%, 2.3-2.9%, 2.4-3.5%, 2.4-3.4%, 2.4-3.3%, 2.4-3.2%, 2.4-3.1%, 2.4-3.0%, 2.4-2.9%, 2.5-3.5%, 2.5-3.4%, 2.5-3.3%, 2.5-3.2%, 2.5-3.1%, 2.5-3.0%, 2.5-2.9%, 2.6-3.5%, 2.6-3.4%, 2.6-3.3%, 2.6-3.2%, 2.6-3.1%, 2.6-3.0%, 2.6-2.9%, 2.7-3.5%, 2.7-3.4%, 2.7-3.3%, 2.7-3.2%, 2.7-3.1%, 2.7-3.0%, and 2.7-2.9%. Each possibility represents a separate embodiment of the present invention.

In some embodiments, the vanilla extract content in the Petit Beurre spread by weight is in the range of 1.0-4.0%. In some embodiments, the vanilla extract content in the Petit Beurre spread by weight is in the range of 1.0-3.5%, 1.5-4.0%, 1.5-3.5%, 2.0-4.0%, and 2.0-3.5%. Each possibility represents a separate embodiment of the invention. In some embodiments, the vanilla extract content in the Petit Beurre spread by weight is in the range of 2.0-3.4%, 2.0-3.3%, 2.0-3.2%, 2.0-3.1%, 2.0-3.0%, 2.0-2.9%, 2.0-2.8%, 2.1-3.5%, 2.1-3.4%, 2.1-3.3%, 2.1-3.2%, 2.1-3.1%, 2.1-3.0%, 2.1-2.9%, 2.1-2.8%, 2.2-3.5%, 2.2-3.4%, 2.2-3.3%, 2.2-3.2%, 2.2-3.1%, 2.2-3.0%, 2.2-2.9%, 2.2-2.8%, 2.3-3.5%, 2.3-3.4%, 2.3-3.3%, 2.3-3.2%, 2.3-3.1%, 2.3-3.0%, 2.3-2.9%, 2.3-2.8%, 2.4-3.5%, 2.4-3.4%, 2.4-3.3%, 2.4-3.2%, 2.4-3.1%, 2.4-3.0%, 2.4-2.9%, 2.4-2.8%, 2.5-3.5%, 2.5-3.4%, 2.5-3.3%, 2.5-3.2%, 2.5-3.1%, 2.5-3.0%, 2.5-2.9%, 2.5-2.8%, 2.6-3.5%, 2.6-3.4%, 2.6-3.3%, 2.6-3.2%, 2.6-3.1%, 2.6-3.0%, 2.6-2.9%, and 2.6-2.8%. Each possibility represents a separate embodiment of the present invention.

In some embodiments, the Petit Beurre spread comprises: 30-45% (w/w) sugar, 25-35% (w/w) Petit-Beurre biscuit, 15-30% (w/w) vegetable oil or vegetable fat, 0.5-2.5% (w/w) emulsifier, and 1-10% (w/w) an extract providing a flavor of maple, vanilla, or both.

In some embodiments, the Petit Beurre spread comprises: 30-45% (w/w) sucrose, 25-35% (w/w) Petit-Beurre biscuit, 15-30% (w/w) coconut fat, canola oil, or both, 0.5-2.5% (w/w) soy lecithin, and 1-10% (w/w) maple syrup and vanilla extract.

In some embodiments, the Petit Beurre spread comprises: 30-45% (w/w) sucrose, 25-35% (w/w) Petit-Beurre biscuit, 15-20% (w/w) coconut fat, 1-4% (w/w) vanilla extract, 0.5-2.5% (w/w) soy lecithin, 1.5-4% (w/w) maple syrup, and 4-8% (w/w) canola oil. In some embodiments, the cocoanut fat is hardened coconut fat.

In some embodiments, the Petit Beurre spread comprises: 37-40% (w/w) sucrose, 28-31% (w/w) Petit-Beurre biscuit, 17-19% (w/w) hardened coconut fat, 2-3.5% (w/w) vanilla extract, 1-2% (w/w) soy lecithin, 2-3.5% (w/w) maple syrup, and 6-8% (w/w) canola oil.

In some embodiments, the Petit Beurre spread comprises: about 39% (w/w) sucrose, about 29% (w/w) Petit-Beurre biscuit, about 18% (w/w) hardened coconut fat, about 2.5% (w/w) vanilla extract, about 1.5% (w/w) soy lecithin, about 3% (w/w) maple syrup, and about 6.5% (w/w) canola oil.

In some embodiments, the particle size of the Petit Beurre spread disclosed herein is less than 100 μm. In some embodiments, Dv90 particle size distribution of the spread is less than 100 μm. In some embodiments, the Dv90 particle size distribution of the spread is less than or equal to 50 μm. In some embodiments, the Dv90 particle size distribution of the spread is less or equal to 45 μm, 40 μm, and 35 μm. Each possibility represents a separate embodiment of the present invention. In some embodiments, Dv90 particle size of the spread is less than or equal to 30 μm.

In some embodiments, the Dv90 particle size of the spread is in the range of 20-50 μm, 25-50 μm, 20-40 μm, 25-40 μm, 20-35 μm, and 25-35 μm. Each possibility represents a separate embodiment of the present invention. In some embodiments, the Dv90 particle size of the spread is in the range of 20-30 μm. In some embodiments, the Dv90 particle size of the Petit Beurre spread is about 24±3 μm.

As used herein, the term “Dv90 particle size” refers to a diameter size (μm) from which 90% of particles in the spread are with diameters below this value.

In some embodiments, the viscosity of the Petit Beurre spread is in the range of: 5,000-20,000 Cp. In some embodiments, the viscosity of the Petit Beurre spread is in the range of: 5,000-15,000 Cp, 5,000-12,000 Cp, 7,000-15,000 Cp, and 7,000-20,000 Cp. Each possibility represents a separate embodiment of the present invention. In some embodiments, the viscosity of the Petit Beurre spread is in the range of: 9,000-12,000 Cp. In some embodiments, the viscosity of the Petit Beurre spread is 10,900±20% Cp.

In some embodiments, the Petit-Beurre biscuit disclosed herein comprises: flour, sugar, at least one vegetable oil, a leavening agent, salt, an emulsifier, a flavoring agent, flour treatment agent, and an acidity regulator.

In some embodiments, the flour in the Petit-Beurre biscuit comprises wheat flour, corn flour, and both. In some embodiments, the flour in the Petit-Beurre biscuit comprises wheat flour. In some embodiments, the sugar in the Petit-Beurre biscuit comprises sucrose.

Vegetable oils used in Petit Beurre biscuits can vary depending on the recipe and the manufacturer. However, common vegetable oils that are often used in Petit Beurre biscuits include: canola oil, sunflower oil, soybean oil, palm oil or refined palm oil, and corn oil.

In some embodiments, at least one vegetable oil in the Petit-Beurre biscuit is palm oil.

In some embodiments, the leavening agent in the Petit-Beurre biscuit is a chemical leavening agent. In some embodiments, the chemical leavening agent is selected from: baking soda (or soda bicarbonate, E500), ammonium bicarbonate (E503), and both.

In some embodiments, the emulsifier in the Petit-Beurre biscuit is soy lecithin.

In some embodiments, the acidity regulator is citric acid.

In some embodiments, the Petit-Beurre biscuit further comprises a preservative and/or antioxidant. In some embodiments, the preservative comprises sulfites (sulfur-based compounds).

As used herein, the term “flour treatment agent”, refers to a food additive or ingredient used in baking to enhance the quality and performance of flour during the bread-making process. These agents are added to flour before or during dough preparation to improve its handling properties, dough elasticity, texture, and final product characteristics. Flour treatment agents can help produce bread and baked goods with better volume, crumb structure, and shelf life. Common functions of flour treatment agents include:
Strengthening Gluten: Some agents help strengthen gluten, a protein in wheat flour that gives bread its structure and texture. This can lead to improved dough elasticity and bread volume.
Enhancing Dough Stability: Flour treatment agents can increase the dough's stability during mixing, proofing, and baking, reducing the risk of dough collapse.
Improving Crust Color: They can promote a desirable crust color and texture in baked goods.
Extending Shelf Life: Certain agents may help extend the shelf life of bread by delaying staling and maintaining freshness.

Non-limiting examples of flour treatment agents include ascorbic acid (vitamin C), enzymes, potassium bromate, and various enzymes and emulsifiers.

“Leavening agents” are substances or ingredients used in leavening of dough during baking, via introducing carbon dioxide gas into the dough, causing it to rise and become light and airy. Leavening agents can be either chemical leavening agents, releasing carbon dioxide gas when reacting with acidic or alkaline ingredients in the dough or batter, or yeasts fermenting sugars in the dough to produce carbon dioxide gas and alcohol. Yeasts include Saccharomyces cerevisiae.

The term “acidity regulator” and “pH control agent” are interchangeably used, and refer to a food additive used in the food and beverage industry to control or modify the pH level of a product. Acidity regulators play a crucial role in maintaining the desired flavor, texture, and shelf stability of various food and beverage items. Non limiting examples for acidity regulators include: citric acid (C₆H₈O₇), lactic acid (C₃H₆O₃), sodium citrate (C₆H₅Na₃O₇), sodium bicarbonate (NaHCO₃), and phosphoric acid (H₃PO₄).

As used herein, the term “Sulfites” encompasses chemical compounds containing sulfur dioxide (SO₂) or sulfite ions (SO₃⁻²). Non limiting examples for the sulfites disclosed herein comprise: sulfur dioxide (SO₂), sodium sulfite (Na₂SO₃), sodium bisulfite (NaHSO₃), potassium metabisulfite (K₂S₂O₅), and sulfur dioxide solution.

In some embodiments, the Petit-Beurre biscuit disclosed herein comprises: wheat flour, sugar, vegetable oils, soda bicarbonate, ammonium bicarbonate, salt, soy lecithin, flavoring agents, sulfite, and citric acid.

In some embodiments, the Petit-Beurre biscuit disclosed herein comprises: 50-60% (w/w) wheat flour, 15-20% (w/w) sugar, 15-25% (w/w) vegetable oils, less than 1% (w/w) leavening agents (e.g., baking soda; E500 and ammonium bicarbonate; E503), less than 1% (w/w) salt, less than 1% (w/w) emulsifier (e.g., soy lecithin), less than 1% (w/w) flavoring agents, less than 1% (w/w) flour treatment agent, and less than 1% (w/w) acidity regulator (e.g., citric acid).

As used herein, the terms “weight per weight (w/w)” refer to a weight ratio of total mixture. In some embodiments, total mixture is before grinding (i.e., initial mixture). In some embodiments, total mixture is post grinding. In some embodiments, total mixture is the final spread.

In some embodiments, wheat fluor comprises: starch, gluten-forming proteins (e.g., gliadin and glutenin), water, ash, lipids, and fibers.

In some embodiments, wheat fluor comprises: 70-75% starch, 8-15% gluten-forming proteins (e.g., gliadin and glutenin), 12-14% water, 0.4-0.6% ash, 1-2% lipids, 2-15% fiber, and less than 1% vitamins (e.g., B vitamins) and enzymes (e.g., amylase).

Starch is a complex carbohydrate and a polysaccharide. The composition of starch primarily consists of two types of glucose polymers:
Amylose: Amylose is a linear chain of glucose molecules linked together by α-1,4 glycosidic bonds. It is a straight-chain polymer, and its structure makes it relatively resistant to enzymatic digestion. Amylose typically constitutes about 15-20% of the starch in most plant sources.
Amylopectin: Amylopectin is a branched-chain polymer of glucose. It consists of α-1,4 glycosidic bonds with occasional α-1,6 glycosidic branch points. Amylopectin is highly branched, and its structure allows for rapid enzymatic digestion. It makes up the majority of the starch in plant sources, accounting for about 80-85% of the total starch content.

Wheat flour is known to contain both soluble and insoluble dietary fiber. In some embodiments, the wheat flour fiber is selected from: cellulose, hemicellulose, arabinoxylan, beta-glucan, and resistant starch.

Wheat fluor lipids are known to comprise: triglycerides, phospholipids, and sterols.

In some embodiments, the Petit Beurre spread disclosed herein comprises: 40-50% sucrose, 15-20% hardened coconut fat, 12-20% wheat flour, 8-15% vegetable oil, 1-3% maple, 1-3% vanilla extract, and 1-4% emulsifier.

In some embodiments, the volatiles of the Petit-Beurre biscuit are selected from the group consisting of: R-(−)-1,2-propanediol, cyclotetrasiloxane (iodomethyl)heptamethyl, Ethyl Vanillin, Phenol 4,4′-(1-methylethylidene) bis, and any combination thereof.

“Volatiles”, or “volatile compounds” are characterized by their ability to transform from a liquid or solid phase to a gas phase when exposed to heat or changes in pressure. Volatiles of the Petit-Beurre biscuit can be determined by various analytic methods. Non limiting examples include Gas Chromatography (GC), GC mass spectrometry (GC-MS),

Proton Nuclear Magnetic Resonance Spectroscopy (1H NMR), Flame Ionization Detector (FID), Solid-Phase Microextraction (SPME), Headspace Analysis (e.g., HS-GC and HS-SPME), Selected Ion Flow Tube Mass Spectrometry (SIFT-MS), and Desorption Electrospray Ionization Mass Spectrometry (DESI-MS).

In some embodiments, the volatiles of the Petit-Beurre biscuit comprises: R-(−)-1,2-propanediol, cyclotetrasiloxane (iodomethyl)heptamethyl, Ethyl Vanillin, Phenol 4,4′-(1-methylethylidene) bis.

In some embodiments, the relative peak area ratio between R-(−)-1,2-propanediol and cyclotetrasiloxane (iodomethyl)heptamethyl is in the range of 1:1 to 3:1, respectively.

In some embodiments, the relative peak area ratio between R-(−)-1,2-propanediol and cyclotetrasiloxane (iodomethyl)heptamethyl is about 2:1.

In some embodiments, the relative peak area ratio between Ethyl Vanillin and cyclotetrasiloxane (iodomethyl)heptamethyl is in the range of 1:1 to 3:1, respectively.

In some embodiments, the relative peak area ratio between Ethyl Vanillin and cyclotetrasiloxane (iodomethyl)heptamethyl is about 2:1.

In some embodiments, the relative peak area ratio between Phenol 4,4′-(1-methylethylidene) bis and cyclotetrasiloxane (iodomethyl)heptamethyl is in the range of 1.5:1 to 3.5:1, respectively.

In some embodiments, the relative peak area ratio between Phenol 4,4′-(1-methylethylidene) bis and cyclotetrasiloxane (iodomethyl)heptamethyl is about 2.5:1, respectively.

It is noted that the term “Relative Peak Area Ratio” is used to describe the ratio of the peak areas of two compounds or analytes in a chromatogram. It provides information about the relative abundance or concentration of one compound in comparison to another in a sample. This ratio is dimensionless and does not have units of weight or volume. Relative Peak Area Ratios are valuable for comparative analysis, but do not provide information about the absolute quantity or concentration without calibration using known standards.

It is understood that the spread disclosed herein can further comprise one or more of the following optional ingredients, without departing from the scope of the invention:
a. vitamins, such as vitamin A, vitamin C, vitamin D, or other essential vitamins to enhance the nutritional value of the composition;
b. minerals, including calcium, iron, zinc, or other minerals to fortify the product;
c. antioxidants, such as tocopherols, ascorbic acid, or natural extracts to extend shelf life and maintain product quality;
d, flavorings and aromatics, including natural or artificial flavorings, herbs, spices, or aromatics to enhance taste and aroma;
e. food-grade color additives to improve the visual appeal of the composition;
f. preservatives; such as citric acid, sodium benzoate, or other preservatives to prolong product shelf life;
g. thickeners and stabilizers; including ingredients like pectin, agar, or xanthan gum to control texture and consistency; and,
h. any additional food-safe ingredients that may be beneficial for taste, texture, shelf life, or nutritional value.

The addition of these optional ingredients may vary according to specific product formulations and the intended use of the food composition. It is within the scope of this invention to include or exclude any combination of these optional ingredients to meet desired product characteristics and regulatory requirements.

### Methods for Producing Petit Beurre Spread Compositions

According to another aspect there is provided a method for preparing a biscuit spread comprising the steps of:

a. providing the Petit Beurre spread ingredients disclosed herein; and,

b. grinding the Petit Beurre ingredients of said step (a) in a mill until a desired texture is achieved.

In some embodiments, the method disclosed herein does not require a preliminary step of crumbling or crushing the Petit Beurre biscuit, separately from the other ingredients, prior step (b). In some embodiments, the method disclosed requires a preliminary step before step (b) of separately crumbling the biscuits into fragments.

In some embodiments, the method disclosed herein comprises gradually adding the sugar and the cookie biscuit to the vegetable fat in the mill. It is suggested that the slow gradual addition of the sugar and the cookies to the oil, in the disclosed cookies: sugar: fat w: w ratios, enables a slow and stable gelatinating process, even in the presence of a non-pre-heated oil, and the presence of reduced content of starch due to the reduced content of cookies.

As used the herein, the terms “grinding” and “milling” are interchangeably used, and refer to the process of breaking down, crushing, or cutting a material or a mixture thereof. After the grinding process the state of the material is changed. In some embodiments, after the grinding of step (b), at least one parameter is changed, wherein at least one parameter is selected from: the particle size, the particle size disposition and the particle shape.

In some embodiments, grinding of step (b) is performed until the Dv90 particle size of the spread is lower than or equal to 50 μm. In some embodiments, grinding of step (b) is performed until the Dv90 particle size of the spread is lower than or equal to 50 μm, 40 μm, and 30 μm. Each possibility represents a separate embodiment of the present invention. In some embodiments, grinding of step (b) is performed until the Dv90 particle size of the spread is about 24±3 μm.

Methods for determining particle size distribution are known in the art, including dynamic image analysis (DIA), static laser light scattering (SLS, or laser diffraction), and sieve analysis.

In some embodiments, the grinding process increases the distribution of uniform particles size compared to a non-milled spread. In some embodiments, increased distribution of uniform particles size is by 10%, 20%, 30%, 40%, 50%, 60%, 70%, 80%, 90%, 100%, 150% or 200%. Each possibility represents a separate embodiment of the invention.

In some embodiments, the grinding process increases the surface area of the Petit Beurre biscuit granules in the spread compared to a non-milled spread. In some embodiments, increased surface area of the Petit Beurre biscuit is by 10%, 20%, 30%, 40%, 50%, 60%, 70%, 80%, 90%, 100%, 150% or 200%. Each possibility represents a separate embodiment of the invention.

In some embodiments, the grinding process reduces the particles size of the Petit Beurre spread compared to a non-milled spread. In some embodiments, reduced particles size of the Petit Beurre biscuit is by 10%, 20%, 30%, 40%, 50%, 60%, 70%, 80%, or 90%, Each possibility represents a separate embodiment of the invention.

In some embodiments, grinding of step (b) is performed until the viscosity of the spread is in the range of: 5,000-20,000 Cp. In some embodiments, grinding of step (b) is performed until the viscosity of the spread is in the range of: 5,000-15,000 Cp, 5,000-12,000 Cp, 7,000-15,000 Cp, and 7,000-20,000 Cp. Each possibility represents a separate embodiment of the present invention. In some embodiments, grinding of step (b) is performed until the viscosity of the spread is in the range of: 9,000-12,000 Cp. In some embodiments, grinding of step (b) is performed until the viscosity of the spread is 10,900±20% Cp.

In some embodiments, the mill is selected from: a ball mill, millstones, an autogenous mill, a buhrstone mill, high pressure grinding rolls, a pebble mill, a rod mill, a semi-autogenous (SAG) mill, a tower mill, and a vertical shaft impactor mill (VSI mill).

In some embodiments, the mill is millstones or a ball mill.

In some embodiments, step (b) is performed in room temperature. In some embodiments, the method disclosed herein does not require heating of the spread.

Achieving the reduced particles size of the spread, as disclosed herein, without the need of heating of the spread ingredients, serves the purpose of preserving the conformation of proteins within the spread and preventing nutrients denaturation or degradation. This preservation allows the addition and preservation of desired vitamins and/or nutritional proteins, ultimately enhancing the overall nutritional value of the spread.

In some embodiments, the method disclosed herein does not require the addition of a cooling agent, after step (b).

The term “cooling agent”, used herein, refers to an ingredient or substance that is added to a mixture immediately after its preparation to rapidly reduce its temperature. This rapid cooling is often necessary to achieve specific texture and consistency in the final product, such as a spread. Cooling agents are typically used to prevent overcooking, maintain the desired color and flavor, and ensure the product sets properly. One common example of a cooling agent in this context is cold water or ice, which is added to hot mixtures to quickly lower their temperature.

In some embodiments, step (b) is performed for a predetermined time.

In some embodiments, the predetermined time is in the range between 2 hr and 4 hr.

As used herein, the term “mill” refers to a device that breaks solid materials, or a mixture of solid and liquid materials, into smaller particles by grinding, crushing, or cutting. The grinding of these materials occurs through mechanical forces that break up the structure by overcoming the interior bonding forces.

As used herein, the terms “millstones” or “mill stones” are interchangeably used and refer to stones used in grinding.

In a preferred example, millstones are composed of two stones: a stationary base with a convex rim known as the bedstone and a concave-rimmed runner stone that rotates. The movement of the runner on top of the bedstone creates a grinding that crushes grain trapped between the stones.

Non limiting examples for mills include Windmill, Watermill, Horse mill, Treadwheel, Ship mill, Arrastra, Roller mill, Stamp mill, Bark mill, Cider mill, Gristmill, Oil mill, Sawmill cuts timber, Starch mill, Sugar mill, Huller or rice mill, Powder mill, Ball mill, Bead mill, Coffee mill, Colloid mill, Conical mill, Disintegrator, Disk mill, Edge mill, Gristmill, Hammer mill, IsaMill, Jet mill, Mortar and pestle, Pellet mill, Planetary mill, Stirred mill, Three roll mill, Vibratory mill, VSI mill, and Wiley mill, Attritor mill, and Cryogenic mill.

“An autogenous mill” or, “a Run of Mine (ROM) mill” refer to a self-grinding device, in which a rotating drum throws larger rocks of ore in a cascading motion which causes impact breakage of larger particles and compressive grinding of finer particles.

“A ball mill” is a rotating cylinder that is partially filled with balls, usually stone or metal, which grind material to the necessary fineness by friction and impact with the tumbling balls. Ball mills typically operate with an approximate ball charge of 30%.

“A high-pressure grinding roll (HPRGs)”, or “roller press”, refers to a device comprising two rollers with the same dimensions, which are rotating against each other with the same circumferential speed. The special feeding of bulk material through a hopper leads to a material bed between the two rollers. Extreme pressure causes the particles inside of the compacted material bed to fracture into smaller particles.

“A Pebble mill” refers to a rotating drum that causes friction between rock pebbles and the milled-material particles.

“A rod mill” is a rotating drum that causes friction and attrition between steel rods and the milled-material particles.

“Semi-autogenous grinding (SAG) mill” is an autogenous mill that additionally uses grinding balls like the ball mill disclosed herein. SAG mills are characterized by their large diameter and short length as compared to ball mills.

“Tower mill”, “vertical mills”, “stirred mills” or “regrind mills”, are known as devices configured for grinding a material comprising small particle sizes, and typically can be used after grinding using ball mills. Similarly to ball mills, grinding balls or pebbles are added to stirred mills to help grind the material.

“Vertical shaft impactor (VSI) mill” is a device that throws rock or ore particles against a wear plate by slinging them from a spinning center that rotates on a vertical shaft. As used herein, the term “about” when combined with a value refers to plus and minus 10% of the reference value. For example, a length of about 1000 nanometers (nm) refers to a length of 1000 nm±100 nm.

It is noted that as used herein and in the appended claims, the singular forms “a”, “an”, and “the” include plural referents unless the context clearly dictates otherwise.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. All combinations of the embodiments pertaining to the invention are specifically embraced by the present invention and are disclosed herein just as if each and every combination was individually and explicitly disclosed. In addition, all sub-combinations of the various embodiments and elements thereof are also specifically embraced by the present invention and are disclosed herein just as if each and every such sub-combination was individually and explicitly disclosed herein.

Additional objects, advantages, and novel features of the present invention will become apparent to one ordinarily skilled in the art upon examination.

### Example 1—Preparation of Non-Dairy Petit-Beurre Spread Made by Mills

### Preparation Process of the Petit-Beurre Spread:

A. Ingredients:
   Powdered sugar-38.9%
   Petit-Beurre biscuit-29.1%
   Hardened coconut fat-18.3%
   Vanilla extract-2.7%
   Soy lecithin-1.6%
   Maple-2.8%
   Canola oil-6.6%
B. procedure: The preparation process involves adding these ingredients to a millstone or ball mill and grinding them until the desired texture is achieved (2-4 hr).

Dv90 particle size of the mills-made non-dairy spread was found to be 22 μm, 23 μm and 27 μm, in three independent measurements.

The viscosity of the mills-made non-dairy spread was examined by Brookfield viscometer, spindle number 4, and was found to be 10,900 Cp.

In a preferred example, powdered sugar is sucrose, hardened coconut fat main component is saturated fats (e.g., Lauric acid and Myristic acid), vanilla extract main component is vanilla flavor compounds (e.g., Vanillin and Ethylvanillin), soy lecithin main component is phospholipids (e.g., Phosphatidylcholine, and Phosphatidylethanolamine), maple main component is a natural maple syrup or maple flavoring compounds, and canola oil main components are monounsaturated and polyunsaturated fats.

### Example 2-Petit Beurre Biscuit

The Petit-Beurre biscuit disclosed herein consists essentially of the following ingredients: wheat flour, sugar, vegetable oils, leavening agents (e.g., baking soda E500 and ammonium bicarbonate, E503), salt, emulsifier (e.g., soy lecithin), flavoring agents, flour treatment agent, and acidity regulator (e.g., citric acid).

In a preferred example, the Petit-Beurre biscuit disclosed herein consists essentially of the following ingredients, in weight per weight ratio (w/w), of total dough before baking: 50-60% (w/w) wheat flour, 15-20% (w/w) sugar, 15-25% (w/w) vegetable oils, less than 1% (w/w) leavening agents (e.g., baking soda; E500 and ammonium bicarbonate; E503), less than 1% (w/w) salt, less than 1% (w/w) emulsifier (e.g., soy lecithin), less than 1% (w/w) flavoring agents, less than 1% (w/w) flour treatment agent, and less than 1% (w/w) acidity regulator (e.g., citric acid).

These ingredients are combined to create the dough for Petit Beurre biscuits, which is then rolled out, cut into rectangles, and baked until they achieve a golden-brown color.

### Example 3-Petit Beurre Biscuit Volatiles, Determined by Gas Chromatography Mass Spectrometry (GC-MS)

The next objective was to determine the composition of volatiles in the Petit-Beurre biscuit sample.

The sample was ground into a fine powder. Headspace of the powder was sampled by SPME and analyzed with Gas Chromatography Mass Spectrometry (GC-MS) according to the following conditions:
1. 20 ml vial with PDMS septum containing about 0.15 g of the sample was heated for 30 min at 50 C.
2. SPME fiber (100 μm PDMS film) was inserted into the vial for an additional 15 min.
3. SPME fiber was desorbed in GC (7890B, Agilent) injector followed by GC-MS (5975 A, Agilent) analysis:
   Injector: 270 C, splitless, 50 ml/min split after 3 min.
   Column: DB5-ms UI, 30 m×0.25 mm×0.25 μm. Helium flow: 1.2 ml/min.
   Oven: 35 C (hold 3 min), 15 C/min to 300 C (hold 0.33 min).
   Transfer Line: 250 C.
   Scan: 45-450 amu.
   EM Gain: 1.5

Most intensive peaks were integrated, and their mass spectra was compared to the NIST library. Not all samples were identified.

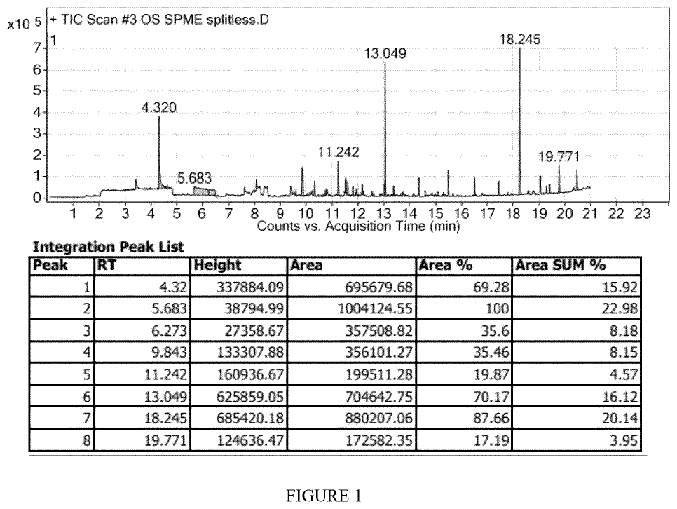

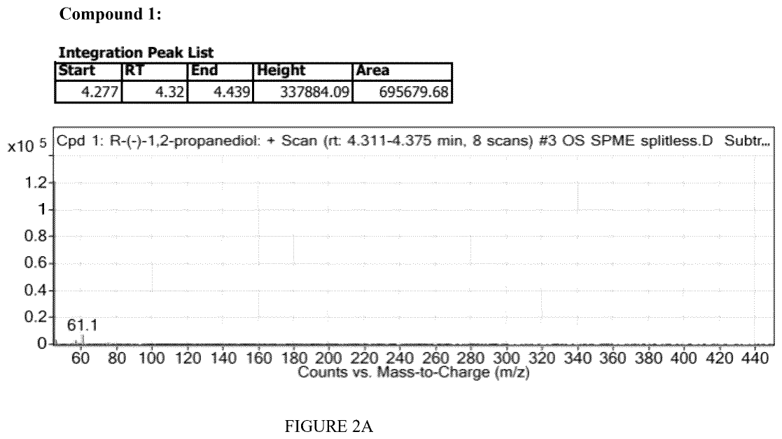

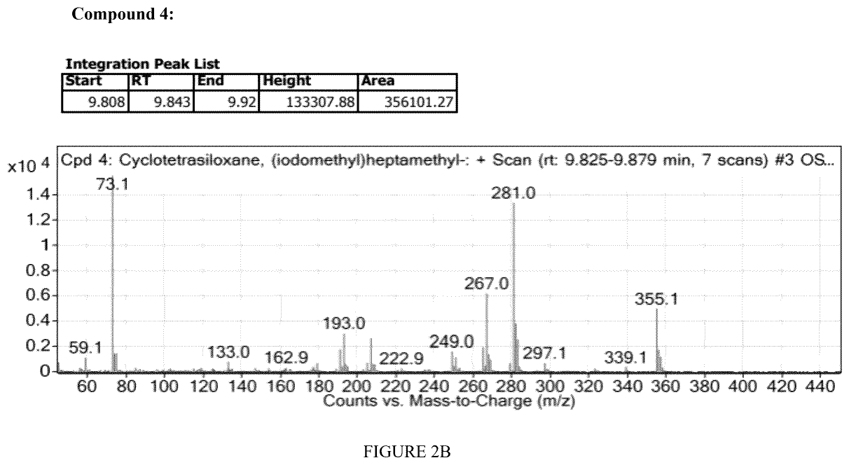

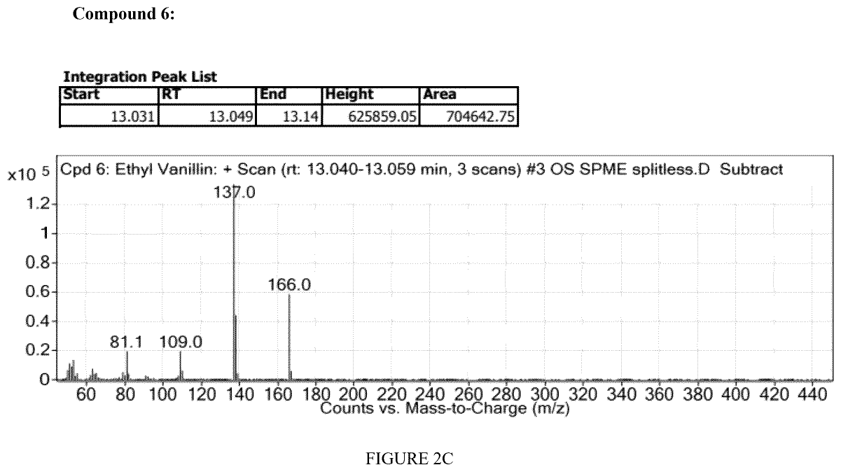

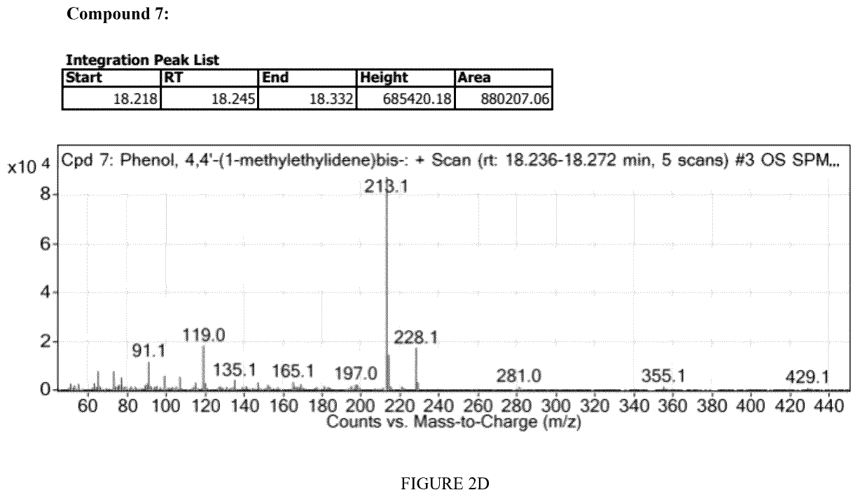

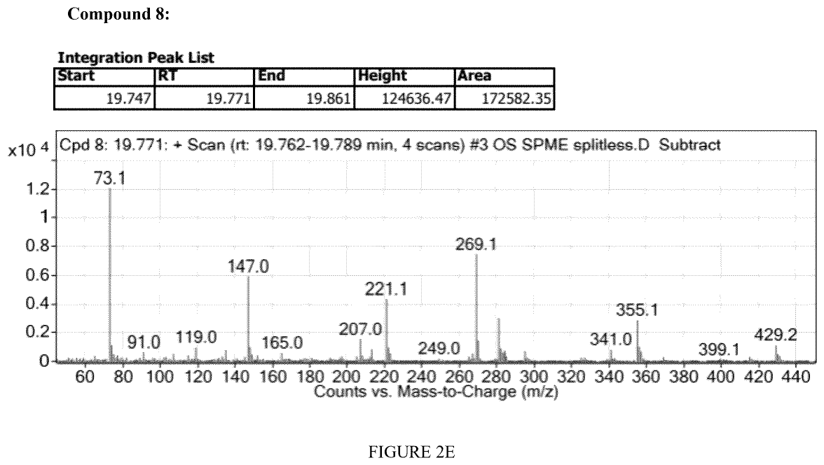

The overall GC spectrum for the Petit-Beurre biscuit sample is presented in FIG. 1. Mass spectra data for each compound (e.g., compounds 1, 4, 6, 7, and 8) is presented in FIG. 2. The identified formulas are summarized in Table 1.

TABLE 1
Summary of GC-MS for Petit-Beurre Sample

| Compound | Name | Formula | Score | RT | Area | CAS |
|---|---|---|---|---|---|---|
| 1 | R-(−)-1,2-propanediol | C3H8O2 | 74.51 | 4.32 | 695680 | 4254-14-2 |
| 4 | Cyclotetrasiloxane, | C8H23IO4Si4 | 71.12 | 9.843 | 356101 | 17882-88-1 |
| | (iodomethyl)heptamethyl- | | | | | |
| 6 | Ethyl Vanillin | C9H10O3 | 97.68 | 13.049 | 704643 | 121-32-4 |
| 7 | Phenol, 4,4′-(1- | C15H16O2 | 89.3 | 18.245 | 880207 | 80-05-7 |
| | methylethylidene)bis- | | | | | |
| 8 | | | | 19.771 | 172582 | |

### Example 4—Organoleptic Test of Petit-Beurre Spread

Three samples were examined by an organoleptic test:
1. Sample 1—Chopper-made dairy Petit-Beurre spread: The sample was prepared by grinding 500 grams of Petit-Beurre biscuits using a grinder. Next, the ground biscuits were thoroughly mixed with 125 ml of sweet cream containing 38% fat and 15 gr of sugar. To achieve the desired spreadable texture, ~125 ml of water was added and mixed until it reached the desired spreadable texture.
2. Sample 2—Mills-made non-dairy Petit-Beurre spread: The sample was prepared as described in EXAMPLE 1.
3. Sample 3—Non-Petit Beurre Biscuit spread: A commercial spread comprising a Non-Petit Beurre biscuit.

The samples were numbered from 1 to 3. The testers were blinded for the samples content. Questionnaires referring to the texture, smell, appearance, and taste of the samples were given to examinees in Hebrew or English. The panel was composed of 38 examiners.

The Questionnaire was based on an organoleptic test comparing between eight biscuits by French and Pakistani panels, as described in: “PAGÈS, J., BERTRAND, C., ALI, R., HUSSON, F. and LÊ, S. (2007), SENSORY ANALYSIS COMPARISON OF EIGHT BISCUITS BY FRENCH AND PAKISTANI PANELS. Journal of Sensory Studies, 22:665-686.”

Each examiner was asked to give each parameter a score from 0 to 10, where 0 stands for “not at all”, and 10 presents “absolute yes”. The examiners were first requested to look at the sample and smell it. The following parameters were examined: attractiveness of the color, smooth texture, compatible texture for spreading, egg smell, milk smell, butter smell, vanilla smell, caramel smell, lemon smell, whisky smell, and overall satisfaction from the smell.

Nest, the examiner was requested to taste the sample, and to provide a score from 0 to 10, to the following parameters: sweetness, saltiness, bitterness, acidity, a texture that is smooth in the mouth, milk taste, butter taste, egg taste, vanilla taste, caramel taste, lemon taste, whisky taste, and overall satisfaction of the taste.

38 examiners participated in the test, 14 females and 24 males. The average age was 46.7. Data are presented as mean±standard error mean (SEM).

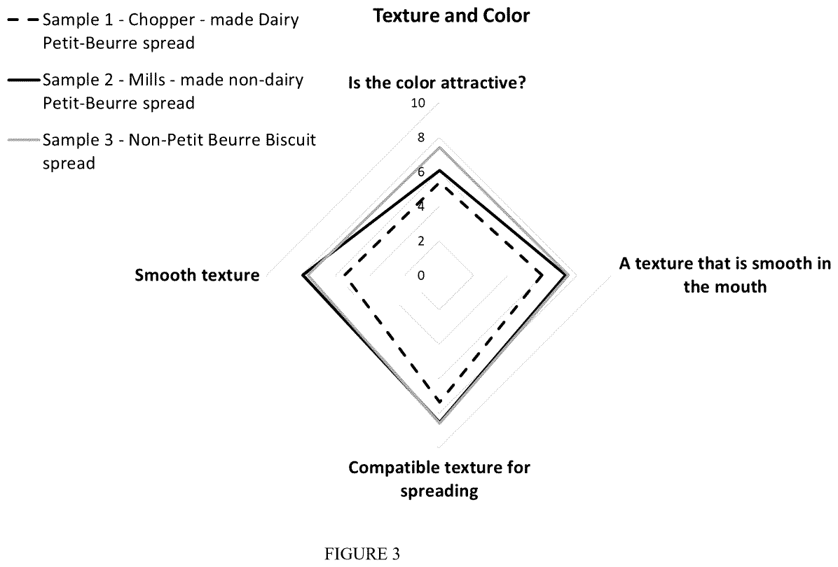

The average scores for each parameter are demonstrated in radar charts, is presented in FIGS. 3-6.

FIG. 3 demonstrates the texture and color of the examined samples.

Mills-made non-dairy Petit-Beurre spread (sample 2) was scored as smoother compared to Chopper-made Dairy Petit-Beurre spread (sample 1) (7.92±0.31 in sample 2 vs. 5.47±0.42 in sample 1, p<0.0001).

Mills-made non-dairy Petit-Beurre spread (sample 2) was scored as more suitable for spreading than chopper-made Dairy Petit-Beurre spread (sample 1) (8.51±0.28 in sample 2 vs. 7.35±0.32 in sample 1, p=0.0112).

The taste results were compatible to the appearance results, and demonstrated that the texture of the mills-made non-dairy Petit-Beurre spread (sample 2) is smoother in the mouth compared to the chopper-made Dairy Petit-Beurre spread (sample 1) (7.31±0.31 in sample 2 vs. 5.93±0.45 in sample 1, p=0.0348).

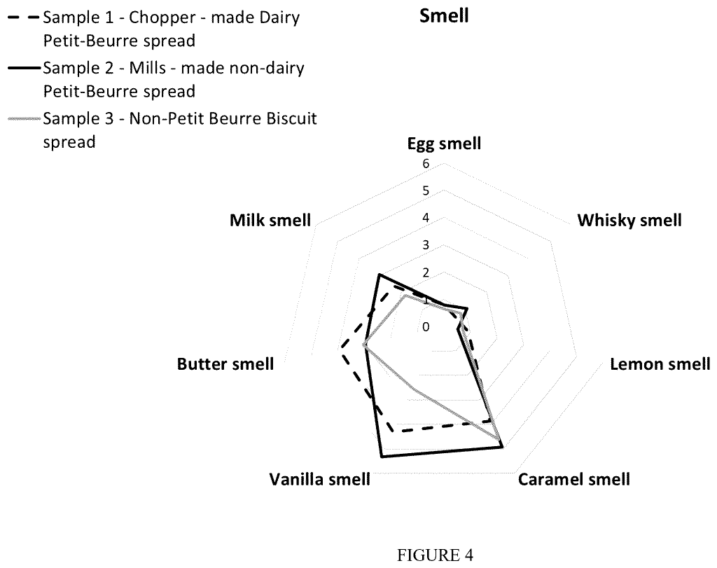

FIG. 4 demonstrates the smell characteristics of the examined samples.

There was a tendency for increased milk smell in the mills-made non-dairy Petit-Beurre spread (sample 2), compared to the non-Petit Beurre Biscuit spread (sample 3) (7.92±0.31 in sample 2 vs. 5.47±0.42 in sample 3, 3.05±0.48 vs. 1.84±0.46, p=0.076), and a significant induction in vanilla smell in non-dairy Petit-Beurre spread (sample 2) compared to the non-Petit Beurre Biscuit spread (sample 3) (5.31±0.51 in sample 2 vs. 2.56±0.52 in sample 3, p=0.0003).

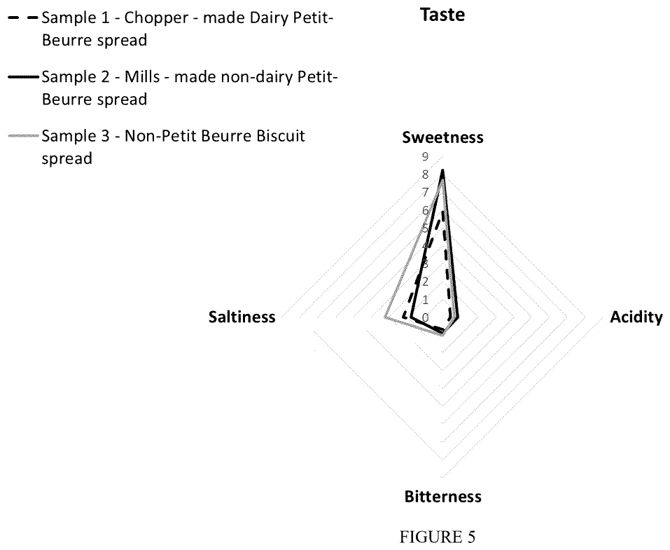

FIG. 5 describes the saltiness, sweetness, acidity and bitterness of the examined samples.

Mills-made non-dairy Petit-Beurre spread (sample 2), was scored as significantly sweeter compared to the chopper-made Dairy Petit-Beurre spread (sample 1) (8.21=0.23 in sample 2 vs. 5.91±0.38 in sample 1, p<0.0001).

Non-Petit Beurre Biscuit spread (sample 3) was scored as saltier compared to the mills-made non-dairy Petit-Beurre spread (sample 2) (3.24±0.43 in sample 3 vs. 1.78±0.31 in sample 2, p=0.014).

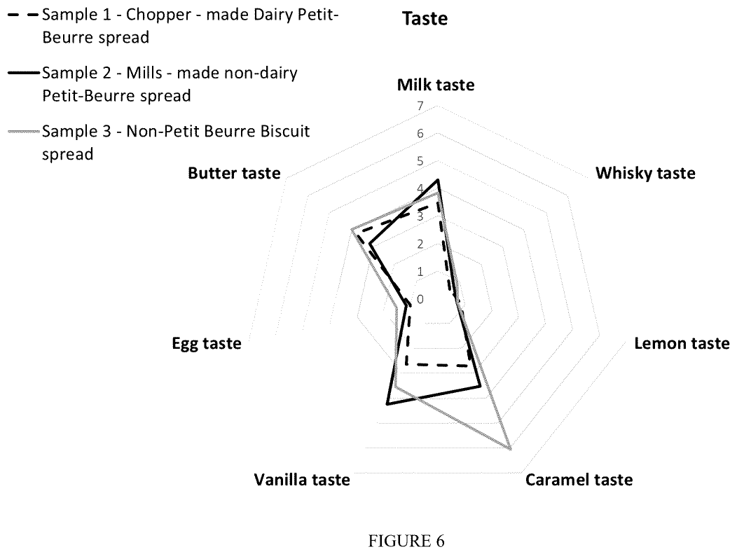

FIG. 6 demonstrates the taste characteristics of the examined samples.

The taste examination revealed increased vanilla taste of the mills-made non-dairy Petit-Beurre spread (sample 2) compared to the chopper-made Dairy Petit-Beurre spread (sample 1) (4.24±0.47 in sample 2 vs. 2.63±0.42 in sample 1, p=0.0224).

Moreover, there was a reduced caramel taste in mills-made non-dairy Petit-Beurre spread (sample 2) compared to the non-Petit Beurre Biscuit spread (sample 3) (3.51±0.52 in sample 2 vs. 6.06±0.55 in sample 3, p=0.0028).

The correlation between the smell and the taste for each examined parameter was next examined, using spearman correlation.

Interestingly, there was a positive correlation between all the examined parameters in the mills-made non-dairy Petit-Beurre spread (sample 2):
Correlation between egg smell and taste, rs (spearman's rho)=0.68236, p=1E-05.
Correlation between milk smell and taste rs=0.35081, p=0.04532.
Correlation between butter smell and taste rs=0.532, p=0.00144.
Correlation between vanilla smell and taste rs=0.38665, p=0.02623.
Correlation between caramel smell and taste rs=0.53298, p=0.00141.
Correlation between lemon smell and taste rs=0.45562, p=0.00771.
Correlation between whisky smell and taste rs=0.71694, p<0.0001.

The strongest correlation was found between the smell and the taste of an egg and of whisky.

In conclusion, all parameters indicating a smoother homogenized spread were increased in the mills-made non-dairy Petit-Beurre spread (sample 2), compared to the chopper-made Dairy Petit-Beurre spread (sample 1). Moreover, there was an increased vanilla taste of the mills-made non-dairy Petit-Beurre spread (sample 2) compared to the chopper-made dairy Petit-Beurre spread (sample 1), and it was positively correlated with a vanilla smell.

It is also noted that the organoleptic examination revealed 34.25% increased overall taste satisfaction from the mills-made non-dairy Petit-Beurre spread (sample 2), compared to the chopper-made dairy Petit-Beurre spread (sample 1). This observation strongly suggests that the smaller particle size in sample 2 is associated with an enhanced product satisfaction.

1-15. (canceled)

16. A cookie biscuit spread comprising 30-45% (w/w) sugar, 25-35% (w/w) cookie biscuit, and 15-35% (w/w) vegetable fat, wherein said spread is characterized by a viscosity in the range of: 5,000-15,000 Cp at 40° C.

17. The cookie biscuit spread of claim 16, characterized by a Dv90 particle size of less than or equal to about 30 μm, said Dv90 is a diameter at which 90% of the particles by volume are smaller than or equal to said diameter.

18. The cookie biscuit spread of claim 16, further comprising 0.5-2.5% (w/w) emulsifier.

19. The cookie biscuit spread of claim 16, further comprising 1-10% (w/w) an extract providing a flavor of maple, vanilla, or both.

20. The cookie biscuit spread of claim 16, wherein said sugar is sucrose.

21. The cookie biscuit spread of claim 16, wherein said vegetable fat is coconut fat, canola oil, palm oil or any combination thereof.

22. The cookie biscuit spread of claim 18, wherein said emulsifier is soy lecithin.

23. The cookie biscuit spread of claim 16, comprising 30-45% (w/w) sucrose, 25-35% (w/w) cookie biscuit, 15-20% (w/w) coconut fat, 1-4% (w/w) vanilla extract, 0.5-2.5% (w/w) soy lecithin, 1.5-4% (w/w) maple syrup, and 4-8% (w/w) canola oil.

24. A method for preparing a biscuit spread comprising the steps of:
a. providing a cookie spread ingredients at room temperature comprising 30-45% (w/w) sugar, 25-35% (w/w) cookie biscuit, and 15-35% (w/w) vegetable fat; and,
b. gradually adding said sugar and said cookie biscuit to said vegetable fat in a mill and grinding said cookie spread ingredients in said mill until a desired texture is achieved, wherein said grinding is performed at room temperature,
further wherein said desired texture is characterized by a Dv90 particle size of less than or equal to about 30 μm, said Dv90 is a diameter at which 90% of the particles by volume are smaller than or equal to said diameter.

25. The method of claim 24, wherein said desired texture is characterized by viscosity within the range of: 9,000-12,000 Cp at 40° C.

26. The method of claim 24, wherein said mill is selected from: a ball mill, millstones, an autogenous mill, a buhrstone mill, high pressure grinding rolls, a pebble mill, a rod mill, a semi-autogenous (SAG) mill, a tower mill, and a vertical shaft impactor mill (VSI mill).

27. The method of claim 26, wherein said mill is millstones or a ball mill.

28. The method of claim 24, wherein said step (b) is performed for a predetermined time.

29. The method of claim 24, wherein said gradually adding is adding said sugar and said cookie biscuit during a period of about 30 minutes.

30. The method of claim 28, wherein said predetermined time is in the range between 2 hr and 4 hr.
